(19) United States
(12) Patent Application Publication
(10) Pub. No.: US 2004/0014384 A1
(43) Pub. Date: Jan. 22, 2004

(54) Insulative and wrappable band

(76) Inventor: Alexander Sloot, Sugarloaf, PA (US)

Correspondence Address: ST. ONGE STEWARD JOHNSTON & REENS, LLC, 986 BEDFORD STREET, STAMFORD, CT, 06905-5619, US

(21) Appl. No.: 10/201,084

(22) Filed: Jul. 22, 2002

(51) Int. Cl. B32B 27/12

(52) U.S. Cl. 442/131

(57) ABSTRACT

The invention relates to an insulative and wrappable band having a coil and at least one film of reflective material. The coil includes a length and a width, where the width has a bowed shape extending along the length. Further, the coil is preloaded to curl from an open position to a curled position, where the open position is where the length is generally straight, or flat, as opposed to being curled. The film of reflective material provides the insulative properties to the band and is placed along the length in at least one localized area for reflecting radiative temperature changes. Radiative temperature changes is defined to be the transfer of heat and/or cold through radiation. The film of reflective material is any material capable of reflecting radiative temperature changes and may be a metalized foil.

### FIELD OF THE INVENTION

The invention relates to an insulative and self-wrapping band for enclosing about and insulating a variety of articles.

### BACKGROUND OF THE INVENTION

Self-wrapping wrist bands, such as snap bracelets or wrist wraps, that are thin and capable of being coiled around a person's arm are known in the art. Typically, these self-wrapping wrist bands include a spring steel enclosed by a decorative fabric or reflective vinyl.

Coolers are also known in the art to insulate various articles, typically cans or cups having a round shape, and help maintain the temperature of the articles' contents. A typically cooler is a foam structure having a fixed geometry to accommodate standard sized cans and cups. A thermos is another type of insulative structure for consumers who choose to insulate a beverage. The thermos is also of a fixed geometry for holding a predetermined maximum volume of liquid. Larger coolers, such as those usually having a rectangular shape and generally capable of holding approximately 16 to 54 quarts of liquid, insulate articles capable of fitting within the cooler. Similar to the thermos, the larger coolers are also of a fixed geometry for holding a predetermined maximum volume.

Publication US 2001 0031322-A1 to Sloot (“Sloot”) discloses a self-wrapping decorative article for wrapping about a person's limb, a post, a column, or other similar structures. The self-wrapping decorative article includes an elongated wrapping member placed between a pair of layers. The elongated wrapping member is a coil, spring, clamp, or hinge and has the ability to spring closed and, when held open, maintain an open position until actuated to spring closed. The layers are disclosed to be either vinyl, reflective, foam, or a polymeric material.

A disadvantage of the coolers of the prior art is that they are typically incapable of holding, in the case of a thermos or larger rectangular cooler, liquid or articles larger than the maximum capacity of the cooler. Further, when a smaller amount of liquid or articles are placed within the typically cooler, the cooler's fixed geometry prevents the cooler from conforming to the reduced need and, hence, the user will need to transport a cooler that is unnecessarily larger, and possibly burdensome, for the required task. Moreover, foam coolers typically break or crumble easily.

Although conformable to a shape of the object about which it is wrapped, the self-wrapping decorative article of Sloot does not typically have insulating benefits.

What is desired, therefore, is a device having insulative properties and that can be wrapped around an object desired to be insulated. What is also desired is a wrappable band that is conformable to the shape of the object, whether the object has a round or polygonal geometry. A further desire is to provide a wrappable band that resists breakage.

### SUMMARY OF THE INVENTION

Accordingly, it is an object of the invention to provide a device having insulative properties and that can be wrapped about an object desired to be insulated.

Another object of the invention is to provide an insulative and wrappable band that conforms to variously shaped objects.

A further object of the invention is to provide a band made with pliable or bendable materials to resist breakage.

These and other objects of the invention are achieved by provision of an insulative and wrappable band having a coil and at least one film of reflective material. The coil includes a length and a width, where the width has a bowed shape extending along the length. Further, the coil is preloaded to curl from an open position to a curled position, where the open position is where the length is generally straight, or flat, as opposed to being curled. The film of reflective material provides the insulative properties to the band and is placed along the length in at least one localized area for reflecting radiative temperature changes. Radiative temperature changes is defined to be the transfer of heat and/or cold through radiation. The film of reflective material is any material capable of reflecting radiative temperature changes and may be a metalized foil.

The film of reflective material may be placed in any location of the insulative and wrappable band. In some embodiments, the film is spaced apart from the coil. In other embodiments, the film is in contact with the coil. Similarly, the film may be integrally formed with other layers, such as a light layer, cloth layer, plastic layer, the coil, and combinations of these. Although the film and coil are all that are needed for the band to properly function in accordance with the invention, because the coil and film provide both insulative and wrappable characteristics, optional layers, such as the light layer, cloth, and plastic layers, may provide a more desirable band depending on the application.

The light layer may be used as an outer layer of the band for reflecting light and improving visibility. The plastic layer may be placed in contact with the coil for facilitating the coil's movement. The cloth material may be used as an inner layer for absorbing moisture from the object to be insulated and, in the case where the band is being worn by a user, for providing comfort to the user. A foam layer may be applied to the band to enhance the insulative properties. To further enhance the insulative properties, more than one film of reflective material may be used in the band.

The film layer or layers of reflective material may also be placed along select portions of the length of the band, such as areas where radiative temperature changes are more concentrated. Additionally, the film of reflective material may have varying dimensions as it extends along the length. Similarly, this enables the band to concentrate the film of reflective material in selected areas.

In a further aspect of the invention, the insulative and wrappable band includes a coil having a length, a width, an inner surface, and an outer surface. The width also has a bowed shape where the bowed shape extends along the length. The coil is preloaded to curl from an open position to a curled position, the open position being where the length is generally straight, or flat. The band also includes a plastic material in contact with both the inner surface and the outer surface for facilitating coil movement in cooperation with the other layers. A first heat reflective layer is provided in contact with the plastic material on a side of the inner surface for reflecting radiative temperature changes, followed by a first cloth material in contact with the first heat reflective layer. A second cloth material is provided in contact with the plastic material on a side of the outer surface, followed by a second heat reflective layer in contact with the second cloth material for reflecting radiative temperature changes. Finally, an outer most light layer is provided in contact with the second heat reflective layer for reflecting, emitting, or manipulating light.

The invention and its particular features and advantages will become more apparent from the following detailed description considered with reference to the accompanying drawings.

### BRIEF DESCRIPTION OF THE DRAWINGS

FIG. 1 depicts the insulative and wrappable band in accordance with the invention.

FIG. 2 depicts a cross sectional view of the insulative and wrappable band of FIG. 1.

FIG. 3 depicts an alternative embodiment of the band shown in FIG. 1.

FIG. 4a depicts the insulative and wrappable band being wrapped about a cylindrical object.

FIG. 4b depicts the insulative and wrappable band being wraped about a 4 sided object.

FIG. 5 depicts the insulative and wrappable band being worn by a user.

### DETAILED DESCRIPTION OF THE DRAWINGS

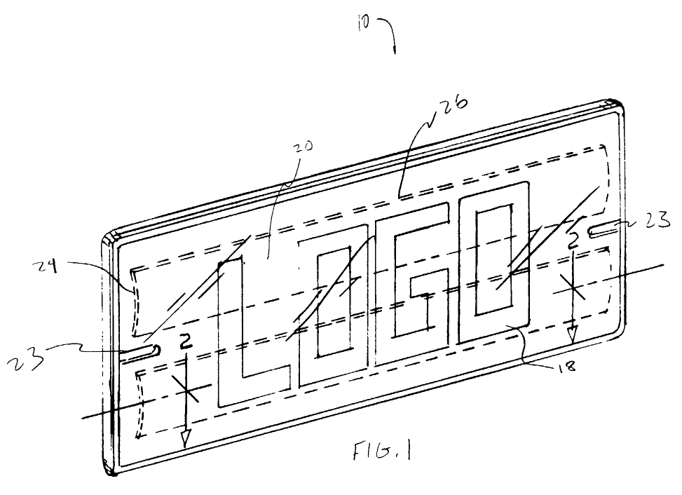

FIG. 1 depicts the insulative and wrappable band 10 in accordance with the invention. Band 10 is for insulating and wrapping about various objects. Further, band 10 is reusable and capable of wrapping about objects having varying geometries and sizes. In addition, band 10 is applicable for insulating objects to maintain either heat or coldness. Moreover, band 10 is made of bendable materials and, therefore, resists breakage.

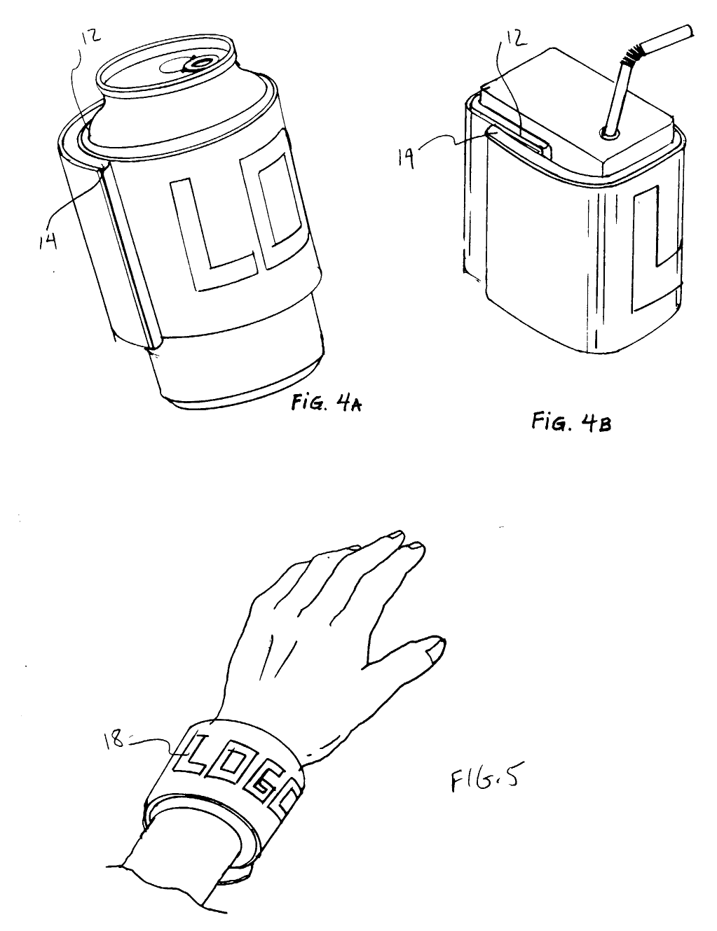

For example, as shown in FIG. 4a, band 10 is wrapped about cylindrical container, such as a soda can, to maintain the can's temperature, which is typically cooler than a surrounding temperature, although band would just as effectively maintain the can's temperature if it was warmer than the surrounding temperature. FIG. 4b shows band 10 wrapped about a 4 sided container, such as a juice container. As shown in FIG. 5, band 10 is wrapped about a person's wrist to maintain heat or body temperature, although the preferred purpose of wrapping about a person's body is for its light properties, such as being light reflective, wherein the band includes such properties as described more fully below.

Further, band 10 is portable in that it may be worn, instead of carried or stored, when not in use. As FIGS. 4a, 4b, and 5 show, band 10 can be wrapped about generally round or 4 sided objects. Band 10 may also be wrapped about polygonal objects in the same manner as described below. Band 10 is wrappable about objects of varying sizes and geometries because first end 12 and second end 14 overlap, when the object is smaller than the length of band 10. However, band 10 is not limited to objects having a girth less than the length of band 10. When the object's girth is larger than the length of band 10, band 10 wraps about the object in the same manner but leaves a portion of the object unwrapped and uninsulated.

Referring to FIG. 1, band 10 may optionally have indicia 18 on a surface of band 10. Indicia 18 may be a logo, trademark, advertising information, a combination thereof, or even a decorative design. Coil 20, shown as dashed lines and hidden inside band 10, is the element that causes band 10 to wrap about the object to be insulated. Coil 20 is more particularly depicted in FIG. 2, which is a cross section of band 10 in FIG. 1.

Coil 20 is an elongated steel member having a tendency to roll up, or spring closed. The tendency for coil 20 to roll up is similar to a coil spring being preloaded to coil up. In other embodiments, coil 20 is a coil spring. It is understood that coil 20 may be a clamp or hinge so long as it has the capability of springing closed from a flat position. To keep coil 20 from continuously being in the rolled up, or closed, position, coil 20 includes a width 24 having a bowed shape, as shown in FIG. 1. The bowed shape, when maintained, inhibits coil 20 from springing closed. The bowed shape is maintained when coil 20, and band 10, is held in the flat position shown in FIG. 1. When the bowed shape of coil 20 is not maintained along any section of the length 26 of coil 20, coil 20 will then automatically spring closed, as it is preloaded to curl up, about the object to be wrapped. Hence, even though only one section of the bowed width of coil 20 is not maintained, the entire coil 20 will automatically roll up. Width 24 will not be maintained when band 10 or coil 20 is bent slightly from the flat position of FIG. 1.

Coil 20 is preferably made of a high carbon steel having a thickness between approximately 0.004 and 0.010 inches and more preferably in the range of approximately 0.005 and 0.006 inches. Width 24 of coil 20 is approximately 1 inch and length 26 varies to manufacture bands 10 of various lengths for varying applications. To accommodate varying widths of band 10, coil 20, being of approximately 1 inch in width, is merely used in greater or lesser quantities. As shown in FIG. 1, two coils are used. However, numerous coils or only 1 coil may be used for wider or narrower bands.

When more than one coil 20 is used, as shown in FIG. 1, tab 23 is placed near each end of each coil 20 to help maintain the coil's position. Tab 23 is a stitch that extends through band 10 and does not have a determined length. In some embodiments, tab extends the entire length of band 10. In the embodiment shown in FIG. 1, tab 23 has a length long enough to help maintain coil 20 in its place.

Referring again to FIG. 2, band 10 further includes a film 28 of reflective material for reflecting radiative temperature changes. Film 28 is placed along length 26 in at least one localized area.

Radiative temperature changes are defined to be the transfer of either heat and/or cold without direct contact between the object giving off the heat, or coldness, and film 28. The technical term is radiation. However, because the technical term may be confused with radioactive energy, the term radiative temperature changes is used.

Film 28 reflects radiative temperature changes back to the originating source, thereby insulating the object. In the event the object is a juice container, water bottle, or soda colder than the temperature surrounding the object, film 28 reflects the coldness from the object back toward the object. At the same time, film 28 reflects the warmer surrounding temperature back toward the surroundings. Hence, film 28 is the layer that gives band 10 its insulative characteristic.

Film 28 is made of any material capable of reflecting radiative temperature changes. In the preferred embodiment, film 28 is a foil. In other embodiments, film 28 is a metalized material, such as aluminum, stainless steel, or some other alloy that reflects radiative temperature changes. The material of foil 28 need only reflect radiative temperature changes and should not otherwise be a limitation of the invention.

In addition, film 28 need not be placed along the entire length 26. Film 28 may be placed along select portions of length 26 where radiative temperature changes are most desired, such as the middle portion of band 10 as opposed to first and second ends 12 and 14. Although one layer of film 28 is needed for the invention, several layers of film 28 may be used to enhance the insulative properties of band 10. The more layers of film 28, the greater insulation band 10 provides.

As shown in FIG. 2 and for exemplary purposes, two layers of film 28 is used. A layer of film 28 is between inner plastic 30 layer and inner cloth 32 layer on the inner side to reflect radiative temperature changes from the object back toward the object. Another layer of film 28 is placed between outer cloth 32 layer and light layer 42 on the outer side to reflect radiative temperature changes from the surroundings back toward the surroundings.

Although only coil 20 and one film 28 layer are needed for band 10 to properly function having insulative and wrappable capabilities, additional layers may be used to improve band 10. The embodiment shown in FIG. 2 illustrates such a band having optional layers. Plastic 30 layer is placed on both the inner side and outer side of coil 20. Plastic 30 layer facilitates the movement of coil 20 in cooperation with other layers as coil 20 repeatedly curls from an open, flat position to a closed, curled position and vice versa. As coil 20 curls and uncurls, it slides along a surface of other layers, such as film 28 and cloth 32 layer. Plastic 30 layer reduces the sliding friction between coil 20 and these layers. Plastic 30 layer is preferably made of vinyl but any material for reducing friction may be used, such as urethane, polyethelene, or other thermoplastics.

Also as shown in FIG. 2, film 28 layer is placed in contact with plastic 30 layer on the inner side of band 10. Cloth 32 layer is then placed in contact with film 28 layer and is the inner most layer of the embodiment shown in FIG. 2. Cloth 32 layer provides comfort to a user when worn as depicted in FIG. 5 and absorbs moisture, such as condensation, from a cold juice or soda container. Additionally, cloth 32 layer reduces slippage between the object and band 10 and results in enhanced adherence of band 10 to the object. Cloth 32 layer is made of a material that provides the above mentioned benefits, such as cotton or a cotton blend. Typically, cloth 32 layer having the above mentioned benefits often provides a secondary benefit of further having insulative properties.

On the outer side of coil 20, plastic 30 layer is followed by cloth 32 layer. Film 28 is then placed in contact with cloth 32 layer followed by light layer 42, which is the outer most layer of the embodiment shown in FIG. 2. Because film 28 on the outer side of coil 20 reflects temperature from the surroundings back toward the surroundings, it is preferable for film 28 to be closer to the surroundings than cloth 32 layer. Should cloth 32 layer be closer to the surroundings than film 28, cloth 32 layer may absorb the temperature of the surroundings, thereby making it more difficult for film 28 to reflect the radiative temperature changes of the surroundings.

Additionally, in some embodiments, film 28 is integrally formed with light layer 42. In these embodiments, film 28 would be closer to the outer side than cloth 32 layer due to the physical characteristics of light layer 42.

In other embodiments, film 28 is separate from light layer 42. In these embodiments, film 28 may be placed between cloth 32 layer and plastic 30 layer, although the reflective properties of film 28 against the radiative temperature changes from the surroundings is suppressed.

In is understood that the invention should not be limited to the location of film 28 shown in FIG. 2 or described herein. The location of film 28 may be anywhere in band 10 and it is understood that one or more may be used depending upon the insulative properties desired in band 10. In certain embodiments, film 10 may be applied to plastic 30 layer. In other embodiments, film 28 may be applied to cloth 32 layer. In still further embodiments, film 28 is applied to both plastic 30 and cloth 32 layers and may also be placed adjacent to light layer 42.

As shown in FIG. 2, light layer 42 reflects light from the headlights of approaching vehicles at night and is an optional layer for band 10. Light layer 42 enhances visibility, thereby improving the safety of the user. Light layer 42 also improves the chances of a user, as in FIG. 5, wearing band 10 to be seen by motorists. Layer 42 is not limited for reflective purposes only. It may be phosphorescent 50 that it glows in the dark or lights up under black light. It may be holographic or may have other interesting features.

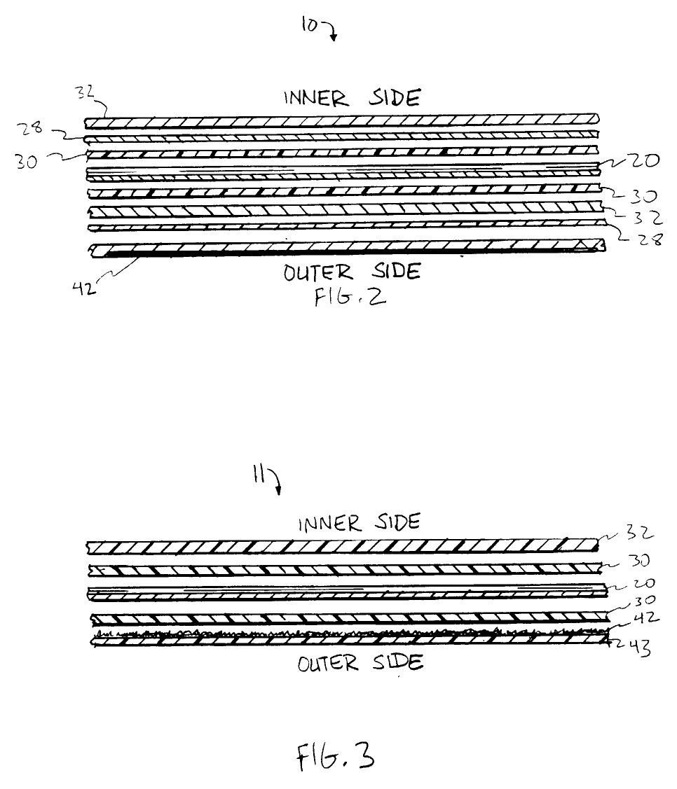

FIG. 3 depicts an alternative embodiment of the invention. FIG. 3 shows a cross section of band 11 having cloth layer 32, plastic layers 30 on either side of coil 20, whereby these layers have the same limitations as band 10 described under FIG. 2. Band 11 further includes a color layer 43. Moreover, light layer 42 may be integrally formed with color layer 43. Light layer 42 may be sporadically oriented metallic pieces, a film, a foil, or any metallic layer that reflects, emits, or manipulates light. Color layer 43 is of any color and may be opaque or semitransparent.

Although the invention has been described with reference to a particular arrangement of parts, features and the like, these are not intended to exhaust all possible arrangements or features, and indeed many other modifications and variations will be ascertainable to those of skill in the art.

What is claimed is:

1. An insulative and wrappable band, comprising:
a coil having a length and a width;
said width having a bowed shape, said bowed shape extending along said length;
said coil being preloaded to curl from an open position to a curled position, the open position being where said length is generally straight; and
a film of reflective material placed along said length in at least one localized area for reflecting radiative temperature changes.

2. The insulative and wrappable band of claim 1, wherein said film is spaced apart from said coil.

3. The insulative and wrappable band of claim 1, wherein said film is in contact with said coil.

4. The insulative and wrappable band of claim 3, wherein said film is integrally formed with said coil.

5. The insulative and wrappable band of claim 1, said coil further comprising an inner side facing an object to be insulated and an outer side facing away from the object to be insulated.

6. The insulative and wrappable band of claim 5, further comprising a reflective element placed on said outer side for reflecting light.

7. The insulative and wrappable band of claim 6, wherein said reflective element is a light sensitive element.

8. The insulative and wrappable band of claim 7, wherein said light sensitive element is phosphorescent.

9. The insulative and wrappable band of claim 7, wherein said light sensitive element glows.

10. The insulative and wrappable band of claim 7, wherein said light sensitive element is reactive to black light.

11. The insulative and wrappable band of claim 1, further comprising a plastic material in contact with said coil for facilitating coil movement.

12. The insulative and wrappable band of claim 1, further comprising a cloth material for providing comfort to a user.

13. The insulative and wrappable band of claim 1, further comprising a foam material for enhancing insulation.

14. The insulative and wrappable band of claim 1, further comprising a second film of reflective material for enhancing reflection of radiation.

15. An insulative and wrappable band, comprising:
a coil having a length, a width, an inner surface, and an outer surface;
said width having a bowed shape, said bowed shape extending along said length;
said coil being preloaded to curl from an open position to a curled position, the open position being where said length is generally straight;
a plastic material in contact with both said inner surface and said outer surface for facilitating coil movement;
a cloth material in contact with said plastic material on a side of said inner surface; and at least one film of reflective material placed along said length in at least one localized area for reflecting radiative temperature changes.

16. The insulative and wrappable band of claim 15, wherein said at least one film is spaced apart from said coil.

17. The insulative and wrappable band of claim 15, wherein said at least one film is in contact with said coil.

18. The insulative and wrappable band of claim 15, said width having varying dimensions along said length.

19. The insulative and wrappable band of claim 15, said length having varying dimensions along said width.

20. An insulative and wrappable band, comprising:
a coil having a length, a width, an inner surface, and an outer surface;
said width having a bowed shape, said bowed shape extending along said length;
said coil being preloaded to curl from an open position to a curled position, the open position being where said length is generally straight;
a plastic material in contact with both said inner surface and said outer surface for facilitating coil movement;
a cloth material in contact with said plastic material on a side of said inner surface;
a heat reflective layer in contact with said plastic material on a side of said outer surface for reflecting radiative temperature changes; and
a light layer in contact with said heat reflective layer.

21. The insulative and wrappable band of claim 20, wherein said heat reflective layer is a metalized film.

22. The insulative and wrappable band of claim 20, further comprising a foam material for enhancing insulation.

23. The insulative and wrappable band of claim 20, wherein said light layer is a light reflective layer for reflecting light.

24. The insulative and wrappable band of claim 23, wherein said light layer further comprises a colored semitransparent layer for providing aesthetic appeal to the band.
